(19) United States
(12) Patent Application Publication
(10) Pub. No.: US 2017/0094244 A1
(43) Pub. Date: Mar. 30, 2017

(54) IMAGE PROCESSING DEVICE AND IMAGE PROCESSING METHOD

(71) Applicant: FUJITSU LIMITED, Kawasaki-shi (JP)

(72) Inventor: Ayu KARASUDANI, Yamato (JP)

(73) Assignee: FUJITSU LIMITED, Kawasaki-shi (JP)

(21) Appl. No.: 15/190,850

(22) Filed: Jun. 23, 2016

(30) Foreign Application Priority Data
Sep. 25, 2015 (JP) 2015-188898

(51) Int. Cl. H04N 13/00; G06T 19/00; H04N 13/02

(52) U.S. Cl. CPC H04N 13/0018; H04N 13/0203; G06T 19/006

(57) ABSTRACT

A method includes determining overlap between a three-dimensional model of a space in which objects are arranged and first three-dimensional information acquired from a distance sensor at a first time point, the distance sensor being along with a camera which captures an image of the space, determining another overlap between the three-dimensional model, the first three-dimensional information, and second three-dimensional information acquired from the distance sensor at a second time point after the first time point, selecting a subset from within the first three-dimensional information and the second three-dimensional information, based on determination results of the overlap and the another overlap, the subset being used for performing positional alignment with the three-dimensional model, estimating a position and an orientation of the camera by the positional alignment using the subset, and generating a display screen displaying an object on the image according to the position and orientation.

### CROSS-REFERENCE TO RELATED APPLICATION

This application is based upon and claims the benefit of priority of the prior Japanese Patent Application No. 2015-188898, filed on Sep. 25, 2015, the entire contents of which are incorporated herein by reference.

### FIELD

The embodiments disclosed herein are related to an image processing technique.

### BACKGROUND

In recent years, augmented reality (AR) techniques have been created for supporting work by superimposing and displaying additional information through computer graphics (CG) or the like on the screen of a terminal device used by a worker in a workplace.

FIG. 11 is a diagram which illustrates an example of an AR technique. As illustrated in FIG. 11, for example, when a user captures an image of a marker 11 and an inspection target 12 using a camera installed in a terminal device 10, object information 13 relating to the marker 11 is displayed on a display screen 10a of the terminal device 10.

Nippon Telegraph and Telephone East Corporation, Nippon Telegraph and Telephone Corporation, Start of Demonstration Experiments on “AR Support Functions”, Sep. 18, 2015, Internet <URL: https://www.ntt-east.co.jp/release/detail/20131024_01.html> describes an application of this AR technique in which an image captured by a worker using a camera is transmitted to a remote assistant not present on site and the remote assistant gives work instructions to the worker while looking at the transmitted captured image. For example, in Nippon Telegraph and Telephone East Corporation, Nippon Telegraph and Telephone Corporation, Start of Demonstration Experiments on “AR Support Functions”, Sep. 18, 2015, Internet <URL: https://www.ntt-east.co.jp/release/detail/20131024_01.html>, the remote assistant performs work support for the worker by applying a marker to a work target included in the captured image and displaying the captured image on which the marker is superimposed on the terminal device of the worker at the work site. Here, the marker in Nippon Telegraph and Telephone East Corporation, Nippon Telegraph and Telephone Corporation, Start of Demonstration Experiments on “AR Support Functions”, Sep. 18, 2015, Internet <URL: https://www.ntt-east.co.jp/release/detail/20131024_01.html> corresponds to object information superimposed and displayed on the image.

For example, in AR technology, by performing positional alignment by comparing a three-dimensional model of the workspace and three-dimensional information acquired from a distance sensor of the terminal device, the position, orientation, and the like of the terminal device are estimated and the position for superimposing and displaying the additional information is adjusted. As techniques for performing the positional alignment, there are “Monte Carlo Localization using Depth Camera in Laser scanned Environment Model” by Ryu Hatakeyama, Satoshi Kanai, and Hiroaki Date, The Japan Society for Precision Engineering meeting proceedings 2013A (0), 633-634, 2013, Japanese Laid-open Patent Publication No. 2010-279023, and the like. In “Monte Carlo Localization using Depth Camera in Laser scanned Environment Model” by Ryu Hatakeyama, Satoshi Kanai, and Hiroaki Date, The Japan Society for Precision Engineering meeting proceedings 2013A (0), 633-634, 2013, the positional alignment is performed by directly comparing the entire region of the three-dimensional model and the three-dimensional information. Other related techniques are disclosed in Japanese Laid-open Patent Publication No. 2004-234349 and Japanese Laid-open Patent Publication No. 2008-046750, and the like.

In Japanese Laid-open Patent Publication No. 2010-279023, in the initial positional alignment, the positional alignment is performed in the same manner as in “Monte Carlo Localization using Depth Camera in Laser scanned Environment Model” by Ryu Hatakeyama, Satoshi Kanai, and Hiroaki Date, The Japan Society for Precision Engineering meeting proceedings 2013A (0), 633-634, 2013, but in the second and subsequent positional alignments, the positional alignment with the three-dimensional model is performed indirectly since the previous three-dimensional information and the current three-dimensional information overlap.

### SUMMARY

According to an aspect of the invention, a method includes determining overlap between a three-dimensional model of a space in which objects are arranged and first three-dimensional information acquired from a distance sensor at a first time point, the distance sensor being along with a camera which captures an image of the space, determining another overlap between the three-dimensional model, the first three-dimensional information, and second three-dimensional information acquired from the distance sensor at a second time point after the first time point, selecting a subset from within the first three-dimensional information and the second three-dimensional information, based on determination results of the overlap and the another overlap, the subset being used for performing positional alignment with the three-dimensional model, estimating a position and an orientation of the camera by the positional alignment using the subset, and generating a display screen displaying an object on the image according to the position and orientation.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram which illustrates a configuration of a remote work support system according to the present embodiment;

FIG. 2 is a diagram (1) for illustrating an overlap portion;

FIG. 3 is a diagram (2) for illustrating an overlap portion;

FIG. 4 is a functional block diagram which illustrates a configuration of an image processing device according to the present embodiment;

FIG. 5 is a diagram which illustrates an example of three-dimensional model information;

FIG. 6 is a diagram for illustrating the processing of a positional alignment unit;

FIG. 7 is a diagram which illustrates an example of a display screen;

FIG. 8 is a flowchart (1) which illustrates a processing order of an image processing device according to the present embodiment;

FIG. 9 is a flowchart (2) which illustrates a processing order of an image processing device according to the present embodiment;

FIG. 10 is a diagram which illustrates an example of a computer which executes a positional alignment program; and

FIG. 11 is a diagram which illustrates an example of an AR technique.

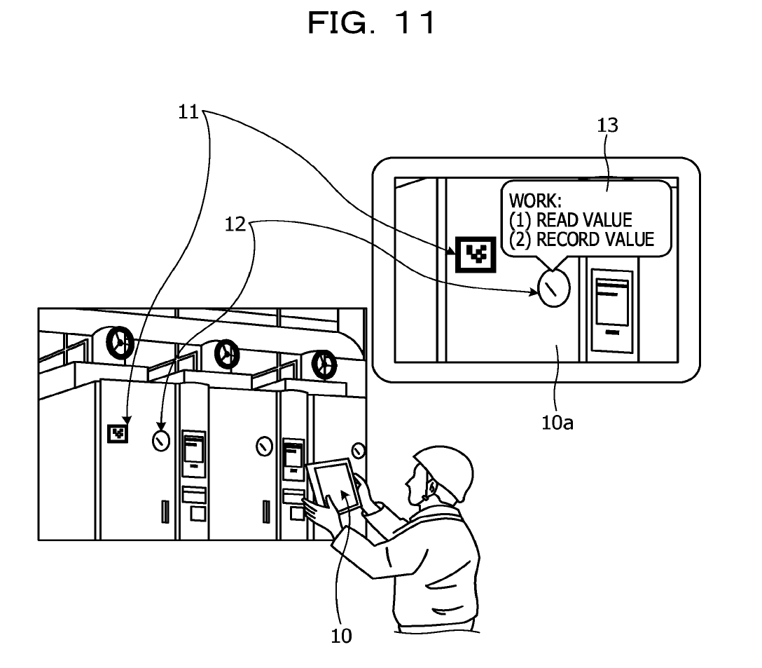

### DESCRIPTION OF EMBODIMENTS

In the related art described above, there is a problem in that it is not possible to perform accurate positional alignment with a small amount of calculation.

For example, in “Monte Carlo Localization using Depth Camera in Laser scanned Environment Model” by Ryu Hatakeyama, Satoshi Kanai, and Hiroaki Date, The Japan Society for Precision Engineering meeting proceedings 2013A (0), 633-634, 2013, the calculation amount is large since a process of directly comparing the entire region of the three-dimensional model with the three-dimensional information which is acquired from the distance sensor is performed every time. On the other hand, in Japanese Laid-open Patent Publication No. 2010-279023, it is possible to reduce the calculation amount in comparison with “Monte Carlo Localization using Depth Camera in Laser scanned Environment Model” by Ryu Hatakeyama, Satoshi Kanai, and Hiroaki Date, The Japan Society for Precision Engineering meeting proceedings 2013A (0), 633-634, 2013, but when the movement of the terminal device is great, the overlap between the previous three-dimensional information and the current three-dimensional information is small and the precision of the positional alignment is decreased.

In addition, in “Monte Carlo Localization using Depth Camera in Laser scanned Environment Model” by Ryu Hatakeyama, Satoshi Kanai, and Hiroaki Date, The Japan Society for Precision Engineering meeting proceedings 2013A (0), 633-634, 2013 and Japanese Laid-open Patent Publication No. 2010-279023, when information relating to the worker's hand or the like not present in the three-dimensional model was included in the three-dimensional information which is acquired from the distance sensor, there were cases where it was not possible to perform the positional alignment with high precision.

In one aspect, the technique which is disclosed in the present embodiment has an object of performing accurate positional alignment with a small amount of calculation.

Below, detailed description will be given of embodiments of the positional alignment device, the positional alignment method, and the positional alignment program which are disclosed in the present application with reference to the accompanying drawings. Here, the disclosure is not limited by the embodiments.

### Embodiments

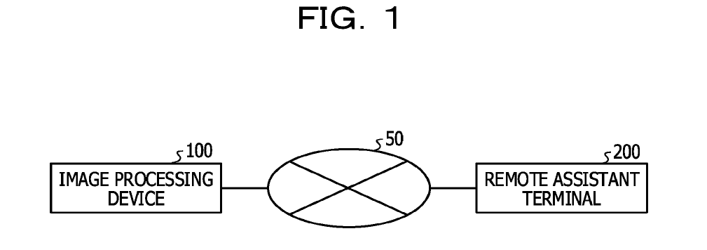

FIG. 1 is a diagram which illustrates a configuration of a remote work support system relating to the present embodiment. As illustrated in FIG. 1, the system has an image processing device 100 and a remote assistant terminal 200. For example, the image processing device 100 and the remote assistant terminal 200 are connected to each other via a network 50. The image processing device 100 is an example of a positional alignment device.

The image processing device 100 is a device used by a worker at the work site. The image processing device 100 provides notification of the information of the image captured by the camera to the remote assistant terminal 200. In addition, in a case of displaying the captured image, the image processing device 100 performs positional alignment of the three-dimensional model of the work space and the three-dimensional information which is acquired from the distance sensor to estimate the position and orientation of a distance sensor 120 and displays additional information according to the position and orientation.

The remote assistant terminal 200 is a device which is used by an assistant who supports the work of a worker. For example, the remote assistant terminal 200 displays a display screen which provides notifications from the image processing device 100 such that the assistant grasps the work situation of the worker and provides various kinds of support.

Next, description will be given of an example of a process of performing positional alignment of the three-dimensional model of the workspace in which the image processing device 100 operates and the three-dimensional information acquired from the distance sensor. In the following description, the three-dimensional model of the workspace is referred to as three-dimensional model information as appropriate.

In a case where the image processing device 100 performs positional alignment, the image processing device 100 selects a positional alignment process from among a first positional alignment process, a second positional alignment process, and a third positional alignment process based on the degree of the overlap between the three-dimensional model information and the three-dimensional information.

The image processing device 100 determines the overlap portion between the three-dimensional model information and the three-dimensional information of the previous frame and makes a determination to execute the first positional alignment process in a case where the overlap portion is less than a first threshold value.

In a case where it is determined that the image processing device 100 makes a determination to not execute the first positional alignment process in the determination described above, the image processing device 100 determines whether or not the movement amount of the camera from the previous frame to the current frame is a predetermined movement amount or more. In a case where the movement amount of the camera from the previous frame to the current frame is a predetermined movement amount or more, the image processing device 100 makes a determination to execute the second positional alignment process.

In a case where the image processing device 100 determines that the movement amount of the camera is less than the predetermined movement amount, the image processing device 100 determines the overlap portion between the three-dimensional model information, the three-dimensional information of the previous frame, and the three-dimensional information of the current frame. In a case where the overlap portion between the three-dimensional information of the previous frame and the three-dimensional information of the current frame is less than a second threshold value, the image processing device 100 makes a determination to execute the second positional alignment process. On the other hand, in a case where the overlap portion between the three-dimensional information of the previous frame and the three-dimensional information of the current frame is the second threshold value or more, the image processing device 100 makes a determination to execute the third positional alignment process.

Next, description will be given of the first positional alignment process, the second positional alignment process, and the third positional alignment process. Description will be given of the first positional alignment process. The image processing device 100 executes the positional alignment of the three-dimensional model and the three-dimensional information by directly comparing the three-dimensional information of the current frame and the three-dimensional model.

Description will be given of the second positional alignment process. The image processing device 100 indirectly specifies the position on the three-dimensional model corresponding to the three-dimensional information of the current frame from the result of the positional alignment of the three-dimensional information of the previous frame and the three-dimensional model and the movement amount of the camera. Then, the image processing device 100 executes the positional alignment of the three-dimensional model and the three-dimensional information by directly comparing the three-dimensional model and the three-dimensional information of the current frame based on the indirectly specified position.

Description will be given of the third positional alignment process. The image processing device 100 projects the overlap portion in the three-dimensional model from the result of the positional alignment of the three-dimensional information of the previous frame and the three-dimensional model and the movement amount of the camera. This overlap portion is a portion which is common to the three-dimensional model, the three-dimensional information of the previous frame, and the three-dimensional information of the current frame. The image processing device 100 performs the positional alignment by comparing the overlap portion and the three-dimensional model.

As described above, in a case where the image processing device 100 performs positional alignment, the image processing device 100 selects a positional alignment process from among a first positional alignment process, a second positional alignment process, and a third positional alignment process based on the degree of the overlap between the three-dimensional model information and the three-dimensional information. For this reason, it is possible to perform the positional alignment with high precision with a small amount of calculation.

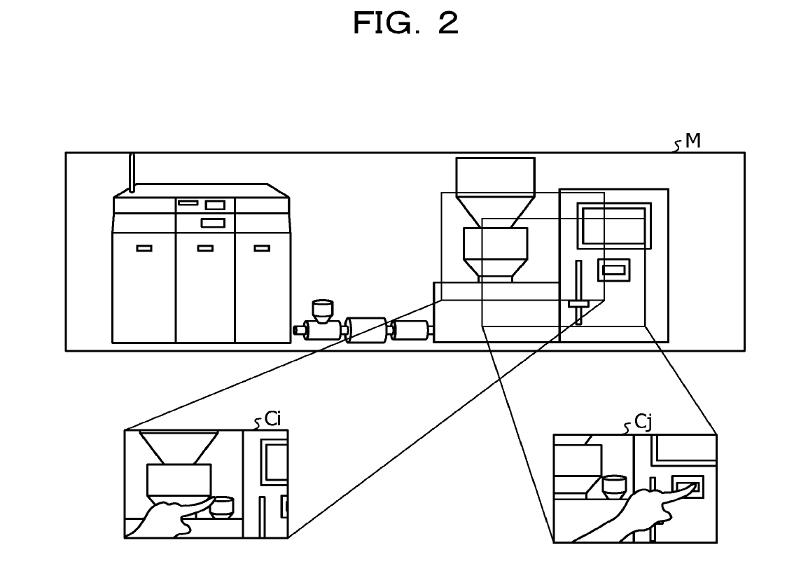

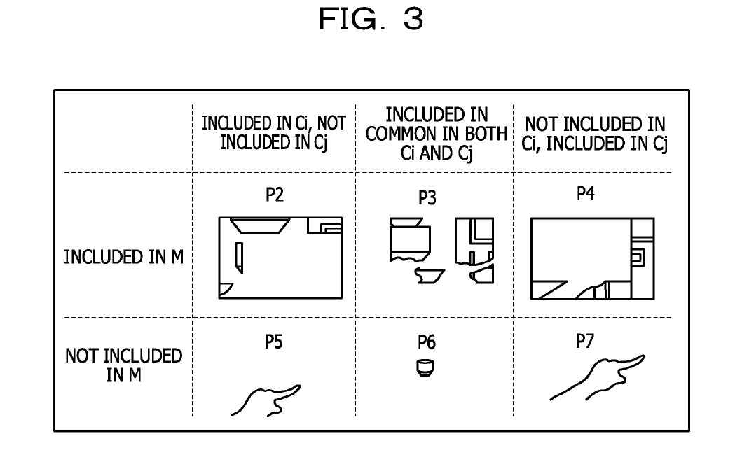

Here, the overlap portion of the three-dimensional model, the three-dimensional information of the previous frame, and the three-dimensional information of the current frame will be defined. FIG. 2 and FIG. 3 are diagrams for illustrating the overlap portion. In the example illustrated in FIG. 2, the three-dimensional model is set as a three-dimensional model M, the three-dimensional information of the previous frame is set as three-dimensional information Ci, and the three-dimensional information of the current frame is set as three-dimensional information Cj.

As illustrated in FIG. 3, in the present embodiment, each overlap portion is divided into the overlap portions P2, P3, P4, P5, P6, and P7. The overlap portion P2 represents a portion which is included in the three-dimensional model M and the three-dimensional information Ci and is not included in the three-dimensional information Cj. The overlap portion P3 represents a portion which is included in and common to the three-dimensional model M, the three-dimensional information Ci, and the three-dimensional information Cj. The overlap portion P4 represents a portion which is included in the three-dimensional model M and the three-dimensional information Cj and is not included in the three-dimensional information Ci.

The overlap portion P5 represents a portion which is not included in the three-dimensional model M or the three-dimensional information Cj and which is included in the three-dimensional information Ci. The overlap portion P6 represents a portion which is not included in the three-dimensional model M and which is included in and common to the three-dimensional information Ci and the three-dimensional information Cj. The overlap portion P7 represents a portion which is not included in the three-dimensional model M or the three-dimensional information Ci and which is included in the three-dimensional information Cj.

For example, the three-dimensional information Ci corresponds to a region where the overlap portions P2, P3, P5, and P6 are combined. The three-dimensional information Cj corresponds to a region where the overlap portions P3, P4, P6, and P7 are combined.

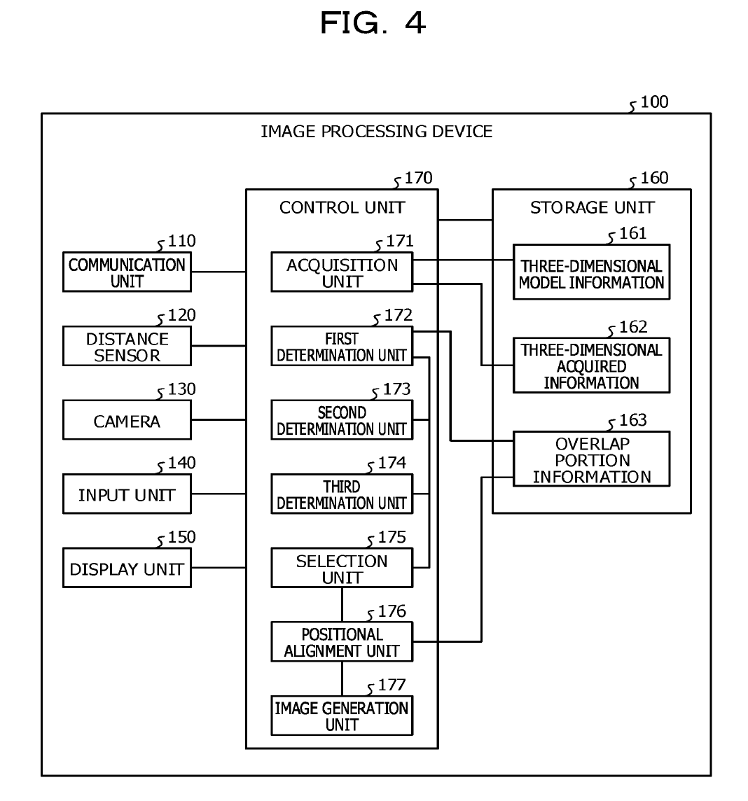

Next, description will be given of the configuration of the image processing device 100 according to the present embodiment. FIG. 4 is a functional block diagram which illustrates a configuration of an image processing device according to the present embodiment. As illustrated in FIG. 4, the image processing device 100 has a communication unit 110, the distance sensor 120, a camera 130, an input unit 140, a display unit 150, a storage unit 160, and a control unit 170. For example, the distance sensor 120 and the camera 130 may be installed in the helmet or the like worn by the worker during work.

The communication unit 110 is a communication device executing data communication with the remote assistant terminal 200 via the network 50. The control unit 170 which will be described below sends and receives data via the communication unit 110.

The distance sensor 120 is a sensor which measures a three-dimensional distance from the distance sensor 120 up to objects included in the measurement range. For example, the distance sensor 120 generates three-dimensional information by measuring three-dimensional distances based on the triangulation method, the time-of-flight, or the like. The distance sensor 120 outputs the three-dimensional information to the control unit 170.

The camera 130 is a device for capturing images in a capture range. The images which are captured by the camera 130 are output to the control unit 170. The camera 130 outputs information about the captured images to the control unit 170. The camera 130 is arranged such that the relative distance to the distance sensor 120 does not change. For example, the camera 130 and the distance sensor 120 may be mounted on a head mounted display (HMD) worn on the head of a worker.

The input unit 140 is an input device for inputting various types of information to the image processing device 100. The input unit 140 corresponds to an input device such as a touch panel or an input button.

The display unit 150 is a display device which displays information output from the control unit 170. The display unit 150 corresponds to a liquid crystal display, a touch panel, or the like.

The storage unit 160 has three-dimensional model information 161, three-dimensional acquisition information 162, and overlap portion information 163. The storage unit 160 corresponds to a storage device such as, for example, a semiconductor memory element such as Random Access Memory (RAM), Read Only Memory (ROM), or flash memory.

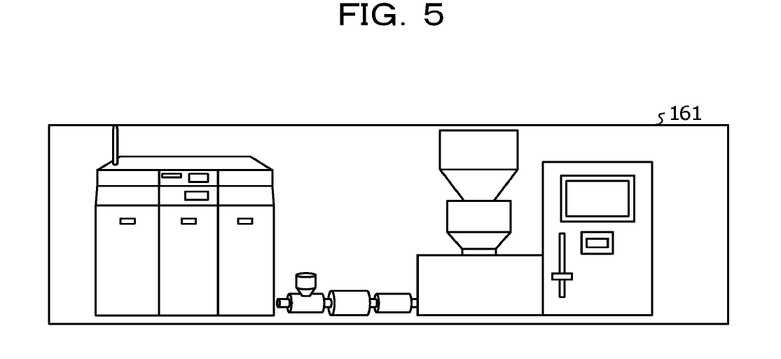

The three-dimensional model information 161 is information which models the shapes of a plurality of objects included in the workspace. For example, the three-dimensional model information 161 arranges a plurality of objects and defines the three-dimensional coordinates at the objects or the shapes of the objects are arranged based on the origins in a global coordinate system set in advance. FIG. 5 is a diagram which illustrates an example of three-dimensional model information. FIG. 5 illustrates the three-dimensional model information 161 as seen from the front.

The three-dimensional acquisition information 162 holds three-dimensional information measured by the distance sensor 120 for every frame.

The overlap portion information 163 has information on the overlap portion between the three-dimensional model information 161 and the three-dimensional information of the current frame. Here, when the three-dimensional information of the current frame at the point of time at which the overlap portion is determined is set as the three-dimensional information Cj, the three-dimensional information of the previous frame is set as the three-dimensional information Ci, information on the overlap portion P3 and the overlap portion P4 is included in the overlap portion information 163 in FIG. 3.

Here, the description returns to FIG. 4. The control unit 170 has an acquisition unit 171, a first determination unit 172, a second determination unit 173, a third determination unit 174, a selection unit 175, a positional alignment unit 176, and a screen generation unit 177. The control unit 170 corresponds to an integrated device such as, for example, an application specific integrated circuit (ASIC) or a field programmable gate array (FPGA). In addition, the control unit 170 corresponds to an electronic circuit such as a CPU or a micro processing unit (MPU).

The acquisition unit 171 acquires three-dimensional model information 161 from the communication unit 110 or the input unit 140. In addition, the acquisition unit 171 acquires the three-dimensional information from distance sensor 120. The acquisition unit 171 stores the three-dimensional model information 161 in the storage unit 160. The acquisition unit 171 stores the three-dimensional information in the three-dimensional acquisition information 162.

The first determination unit 172 is a processing unit which specifies an overlap portion between the three-dimensional model information 161 and the three-dimensional information of the previous frame and determines whether or not the size of the specified overlap portion is a first threshold value or more. The first determination unit 172 outputs the determination result to the selection unit 175.

For example, the first determination unit 172 reads out the overlap portion information 163 and specifies the overlap portion of the three-dimensional model information 161 and the three-dimensional information of the previous frame. Here, at the point of time when the first determination unit 172 carries out the determination, when the three-dimensional information of the current frame is set as the three-dimensional information Cj and the three-dimensional information of the previous frame is set as the three-dimensional information Ci, the overlap portion read out from the overlap portion information 163 is an overlap portion which combines the overlap portion P2 and the overlap portion P3.

Here, the first determination unit 172 may determine that the size of the overlap portion (P2+P3) is the first threshold value or more in a case where the ratio of the overlap portion (P2+P3) with respect to the entire region of the three-dimensional information of the previous frame is, for example, 80% or more.

The second determination unit 173 is a processing unit which determines whether or not the movement amount of the camera 130 is a predetermined movement amount or more. The second determination unit 173 outputs the determination result to the selection unit 175. The second determination unit 173 may calculate the movement amount of the camera 130 in any manner; however, for example, the movement amount of the camera 130 is calculated using the optical flow between the three-dimensional information of the previous frame and the three-dimensional information of the current frame. In addition, the second determination unit 173 may extract characteristic points from each of the three-dimensional information and estimate the movement amount of the camera 130 using homography. In addition, the second determination unit 173 may estimate the movement amount of the camera 130 using an acceleration sensor, an inertia sensor, or the like.

Here, the second determination unit 173 may calculate the overlap portion (P3+P6) of the three-dimensional information of the previous frame and the three-dimensional information of the current frame in a simple manner and, in a case where the overlap portion is a threshold value or more, may determine that the movement amount of the camera is less than a predetermined movement amount.

The third determination unit 174 specifies an overlap portion of the three-dimensional model information 161, the three-dimensional information of the previous frame, and the three-dimensional information of the current frame. The overlap portion of the three-dimensional model information 161, the three-dimensional information of the previous frame, and the three-dimensional information of the current frame corresponds to the overlap portion P3. The third determination unit 174 determines whether or not the size of the overlap portion P3 is a second threshold value or more and outputs the determination result to the selection unit 175.

The selection unit 175 is a processing unit which acquires the determination result of the first determination unit 172, the determination result of the second determination unit 173, and the determination result of the third determination unit 174 and selects a subset of the three-dimensional information for performing positional alignment of the three-dimensional model information 161 based on each of the determination results. The selection unit 175 outputs the information on the selected results to the positional alignment unit 176. In the following, description will be given of specific processes of the selection unit 175.

First, the selection unit 175 refers to the determination result of the first determination unit 172, determines the overlap portion between the three-dimensional model information 161 and the three-dimensional information of the previous frame, and, in a case where the overlap portion is less than the first threshold value, makes a determination to execute the first positional alignment process. In the first positional alignment process, the positional alignment process is executed using the three-dimensional information combining the overlap portions P3 and P4.

In the determination described above, in a case where the selection unit 175 makes a determination not to execute the first positional alignment process, the selection unit 175 makes a determination with reference to the determination result of the second determination unit 173. Specifically, the selection unit 175 determines whether or not the movement amount of the camera from the previous frame up to the current frame is a predetermined movement amount or more. The selection unit 175 makes a determination to execute a second positional alignment process in a case where the movement amount of the camera from the previous frame up to the current frame is a predetermined movement amount or more. In the second positional alignment process, the positional alignment process is executed using the three-dimensional information combining the overlap portions P3 and P4.

In a case where the movement amount of the camera from the previous frame up to the current frame is less than a predetermined movement amount, the selection unit 175 makes a further determination with reference to the determination result of the third determination unit 174. The selection unit 175 makes a determination to execute the second positional alignment process in a case where the overlap portion of the three-dimensional model information 161, the three-dimensional information of the previous frame, and the three-dimensional information of the current frame is less than the second threshold value. On the other hand, the selection unit 175 makes a determination to execute the third positional alignment in a case where the overlap portion of the three-dimensional model information, the three-dimensional information of the previous frame, and the three-dimensional information of the current frame is the second threshold value or more. In the third positional alignment process, the positional alignment is executed using the three-dimensional information of the overlap portion P3.

The positional alignment unit 176 is a processing unit which executes a first positional alignment process, a second positional alignment process, and a third positional alignment process based on the determination results of the selection unit 175. The positional alignment unit 176 outputs the positional alignment result of the three-dimensional information of the current frame to the screen generation unit 177. Here, the positional alignment unit 176 executes a first positional alignment process with regard to the initial positional alignment process where there is no three-dimensional information of the previous frame.

Description will be given of the first positional alignment process. The positional alignment unit 176 executes the positional alignment between the three-dimensional model information 161 and the three-dimensional information in a simple manner by carrying out a direct comparison between the three-dimensional model information 161 and the three-dimensional information of the current frame. For example, the positional alignment unit 176 carries out positional alignment between the three-dimensional information of the current frame and the three-dimensional model information 161 using the Iterative Closest Point (ICP).

The positional alignment unit 176 specifies the overlap portions P3 and P4 by comparing the overlap portion between the three-dimensional model information 161, the three-dimensional information of the current frame, and the three-dimensional information of the previous frame based on the result of carrying out the positional alignment in a simple manner. The positional alignment unit 176 holds the positional alignment result of the three-dimensional information of the previous frame.

The positional alignment unit 176 executes the positional alignment of the overlap portions P3 and P4 by comparing the three-dimensional information combining the overlap portions P3 and P4 and the three-dimensional model information 161. The positional alignment unit 176 specifies the region of the three-dimensional model information 161 which matches with the three-dimensional information of the overlap portions P3 and P4 and determines the matched position and orientation as the position of the three-dimensional information of the current frame.

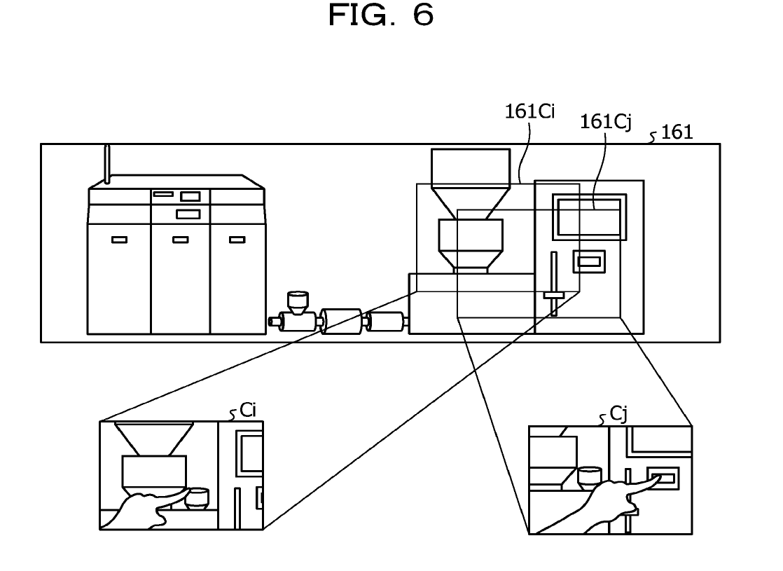

FIG. 6 is a diagram for illustrating the processing of a positional alignment unit. The example illustrated in FIG. 6 illustrates the three-dimensional model information 161, the three-dimensional information Ci of the previous frame, and the three-dimensional information Cj of the current frame. The positional alignment unit 176 specifies the overlap portions P3 and P4 by comparing the three-dimensional model information 161, the three-dimensional information Ci, and the three-dimensional information Cj. For example, the three-dimensional information Ci corresponds to the three-dimensional model information 161 Ci portion of the three-dimensional model information 161. The three-dimensional information Cj corresponds to the three-dimensional model information 161 Cj portion of the three-dimensional model information 161.

Description will be given of the second positional alignment process. The positional alignment unit 176 performs the positional alignment of the three-dimensional information of the current frame by indirectly determining the position on the three-dimensional model information 161 of the three-dimensional information of the current frame based on the positional alignment result of the three-dimensional information of the previous frame and the movement amount of the camera.

The positional alignment unit 176 specifies the overlap portion P3 and P4 by comparing the overlap portions of the three-dimensional model information 161, the three-dimensional information of the current frame, and the three-dimensional information of the previous frame based on the indirectly determined positional alignment result.

The positional alignment unit 176 executes the positional alignment of the overlap portions P3 and P4 by comparing the three-dimensional information combining the overlap portions P3 and P4 and the three-dimensional model information 161. The positional alignment unit 176 specifies the region of the three-dimensional model information 161 which matches with the three-dimensional information of the overlap portions P3 and P4 and determines the matched position and orientation as the position of the three-dimensional information of the current frame.

Description will be given of the third positional alignment process. The positional alignment unit 176 performs the positional alignment of the three-dimensional information of the current frame by indirectly determining the position of the three-dimensional information of the current frame on the three-dimensional model information 161 based on the positional alignment result of the three-dimensional information of the previous frame and the movement amount of the camera.

The positional alignment unit 176 specifies the overlap portion P3 by comparing the three-dimensional information of the current frame and the overlap portion of the three-dimensional model information 161 determined by the positional alignment of the previous frame and the three-dimensional information of the previous frame based on the indirectly determined positional alignment result.

The positional alignment unit 176 executes the positional alignment of the overlap portion P3 by comparing the three-dimensional information of the overlap portion P3 and the three-dimensional model information 161. The positional alignment unit 176 specifies the region of the three-dimensional model information 161 matching with the three-dimensional information of the overlap portion P3 and determines the matched position and orientation as the position of the three-dimensional information of the current frame.

After executing the first positional alignment process, the second positional alignment process, or the third positional alignment process described above, the positional alignment unit 176 re-extracts the overlap portion P3 and the overlap portion P4 and registers the information of the extracted overlap portions P3 and P4 in the overlap portion information 163.

Here, the description returns to FIG. 4. The screen generation unit 177 is a processing unit which generates a display screen based on the positional alignment results of the current frame acquired from the positional alignment unit 176. For example, the screen generation unit 177 generates the display screen by estimating the position and orientation of the image processing device 100 from the positional alignment results and superimposing the additional information on the captured image.

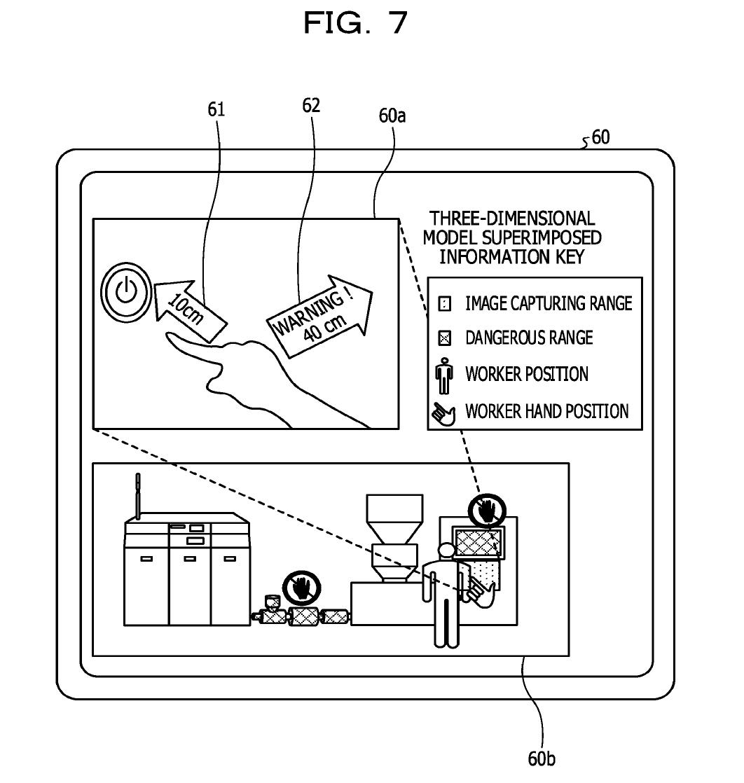

FIG. 7 is a diagram which illustrates an example of a display screen. In the example illustrated in FIG. 7, a captured image 60a and a screen 60b in which the three-dimensional model information 161 is seen from the front are arranged on a display screen 60. In addition, additional information 61 and 62 is superimposed on the captured image 60a. The screen generation unit 177 provides notification of the information of the generated display screen 60 to the remote assistant terminal 200.

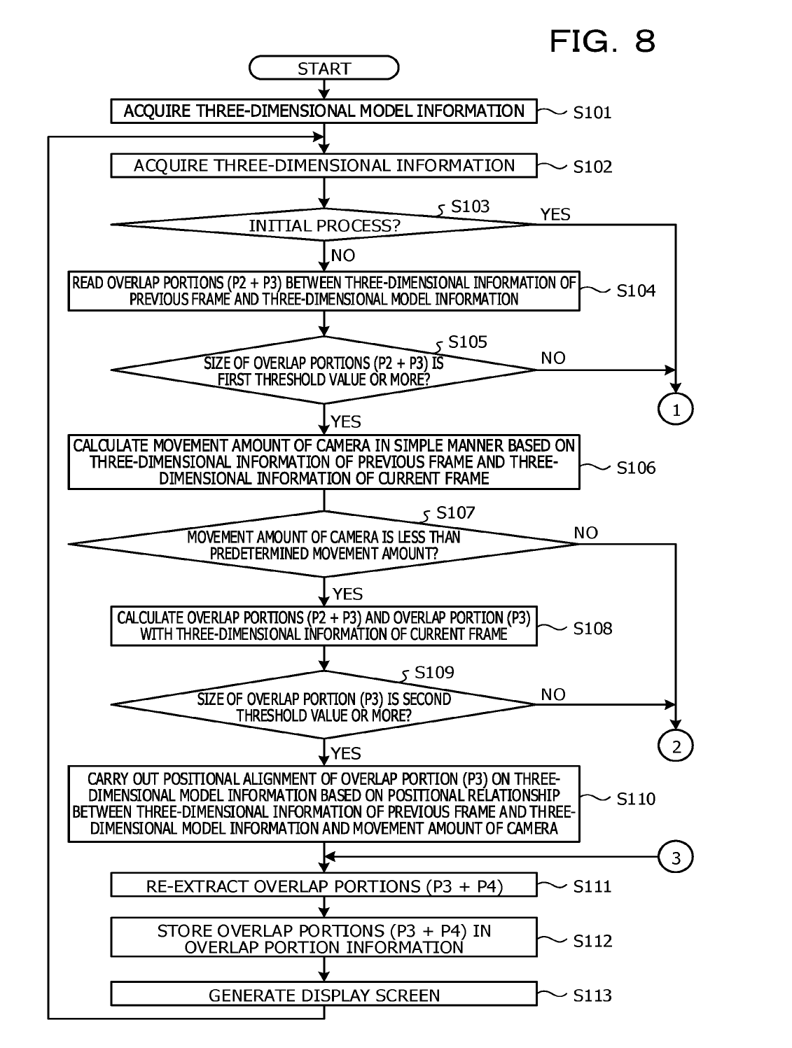

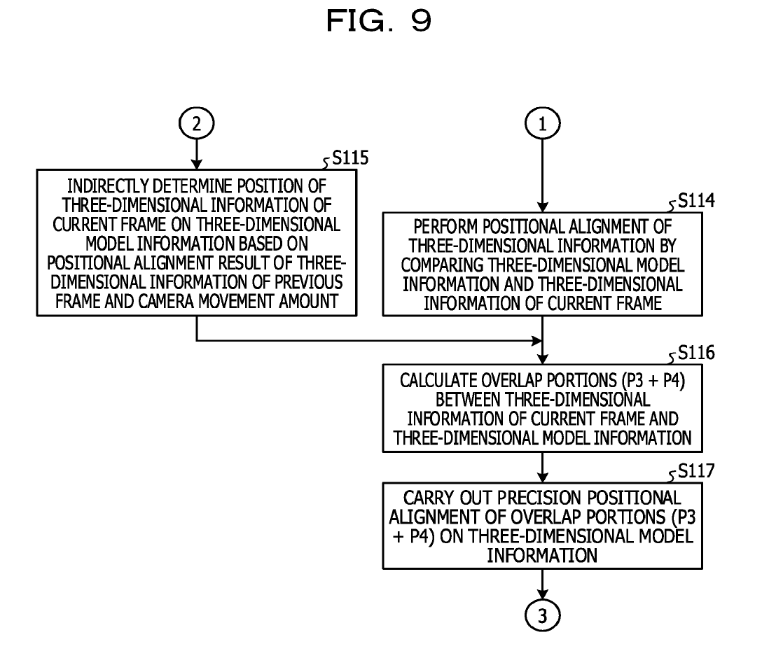

Next, description will be given of the processing order of the image processing device 100 according to the present embodiment. FIG. 8 and FIG. 9 are flow charts which illustrate the processing order of the image processing device according to the present embodiment. As illustrated in FIG. 8, the acquisition unit 171 of the image processing device 100 acquires the three-dimensional model information 161 (step S101) and acquires the three-dimensional information (step S102).

The positional alignment unit 176 of the image processing device 100 determines whether or not the process is the initial process (step S103). The positional alignment unit 176 moves on to step S114 in FIG. 9 in a case where the process is the initial process (step S103, Yes). On the other hand, the positional alignment unit 176 moves on to step S104 in a case where the process is not the initial process (step S103, No).

The first determination unit 172 of the image processing device 100 reads the overlap portion (P2+P3) between the three-dimensional information of the previous frame and the three-dimensional model information 161 from the overlap portion information 163 (step S104). The first determination unit 172 determines whether or not the size of the overlap portion (P2+P3) is the first threshold value or more (step S105). In a case where the size of the overlap portion (P2+P3) is not the first threshold value or more (step S105, No), the process moves on to step S114 in FIG. 9. On the other hand, in a case where the size of the overlap portion (P2+P3) is the first threshold value or more (step S105, Yes), the process moves on to step S106.

The second determination unit 173 of the image processing device 100 calculates the movement amount of the camera in a simple manner based on the three-dimensional information of the previous frame and the three-dimensional information of the current frame (step S106). The second determination unit 173 determines whether or not the movement amount of the camera is less than a predetermined movement amount (step S107). In a case where the movement amount of the camera is not less the predetermined movement amount (step S107, No), the process moves on to step S115 in FIG. 9. On the other hand, in a case where the movement amount of the camera is less than the predetermined movement amount (step S107, Yes), the process moves on to step S108.

The third determination unit 174 of the image processing device 100 projects the three-dimensional information of the current frame onto the three-dimensional model information 161 and calculates the overlap portion (P2+P3) and the overlap portion (P3) with the three-dimensional information of the current frame (step S108).

The third determination unit 174 determines whether or not the size of the overlap portion (P3) is the second threshold value or more (step S109). In a case where the size of the overlap portion (P3) is not the second threshold value or more (step S109, No), the process moves on to step S115 in FIG. 9. On the other hand, in a case where the size of the overlap portion (P3) is the second threshold value or more (step S109, Yes), the process moves on to step S110.

The positional alignment unit 176 of the image processing device 100 carries out positional alignment of the overlap portion (P3) on the three-dimensional model information 161 based on the positional relationship between the three-dimensional information of the previous frame and the three-dimensional model information 161 and the movement amount of the camera (step S110).

The positional alignment unit 176 re-extracts the overlap portion (P3+P4) (step S111) and stores the information of the overlap portions (P3+P4) in the overlap portion information 163 (step S112). The screen generation unit 177 of the image processing device 100 generates the display screen (step S113) and the process moves on to step S102.

Description will be given of step S114 in FIG. 9. The positional alignment unit 176 performs positional alignment of the three-dimensional information (step S114) by comparing the three-dimensional model information 161 and the three-dimensional information of the current frame, and the process moves on to step S116.

Description will be given of step S115 in FIG. 9. The positional alignment unit 176 indirectly determines the position of the three-dimensional information of the current frame on the three-dimensional model information 161 based on the positional alignment result of the three-dimensional information of the previous frame and the movement amount of the camera (step S115) and the process moves on to step S116.

The positional alignment unit 176 calculates the overlap portions (P3+P4) between the three-dimensional information of the current frame and the three-dimensional model information 161 (step S116). In step S116, the positional alignment unit 176 divides the overlap portions (P3+P4) and the other portions (P6+P7). The positional alignment unit 176 carries out precise positional alignment of the overlap portion (P3+P4) with the three-dimensional model information 161 (step S117) and the process moves on to step S111 in FIG. 8.

Next, description will be given of the effects of the image processing device 100 according to the present embodiment. The image processing device 100 determines the size of the overlap portion between the three-dimensional model information 161, the three-dimensional information of the previous frame, and the three-dimensional information of the current frame, and sifts and selects a subset of the three-dimensional information for performing positional alignment with the three-dimensional model information 161 based on the determination results. For this reason, according to the image processing device 100, it is possible to perform accurate positional alignment with a small calculation amount.

The image processing device 100 performs positional alignment using the overlap portion (P3) in a case where the overlap portions (P2+P3) are the first threshold value or more, the movement amount of the camera is less than a predetermined movement amount, and the overlap portion (P3) is the second threshold value or more. For this reason, it is possible to reduce the calculation amount in comparison with a case where all of the three-dimensional information is used. In addition, it is possible to maintain the precision even when the three-dimensional information amount of the calculation target is limited to P3 as the previous frame and the current frame do not move much.

In a case where the movement amount of the camera is a predetermined movement amount or more or a case where the overlap portion (P3) is less than the second threshold value, the image processing device 100 performs the positional alignment using the overlap portions (P3+P4). For this reason, in a case where the camera movement amount is large or a case where the overlap portion is small, it is possible to avoid decreases in the precision by setting the overlap portion for performing positional alignment to be large. In addition, it is possible to reduce the amount of calculation since the positional alignment is performed using the regions (P3+P4) with a smaller overlap than all of the three-dimensional information.

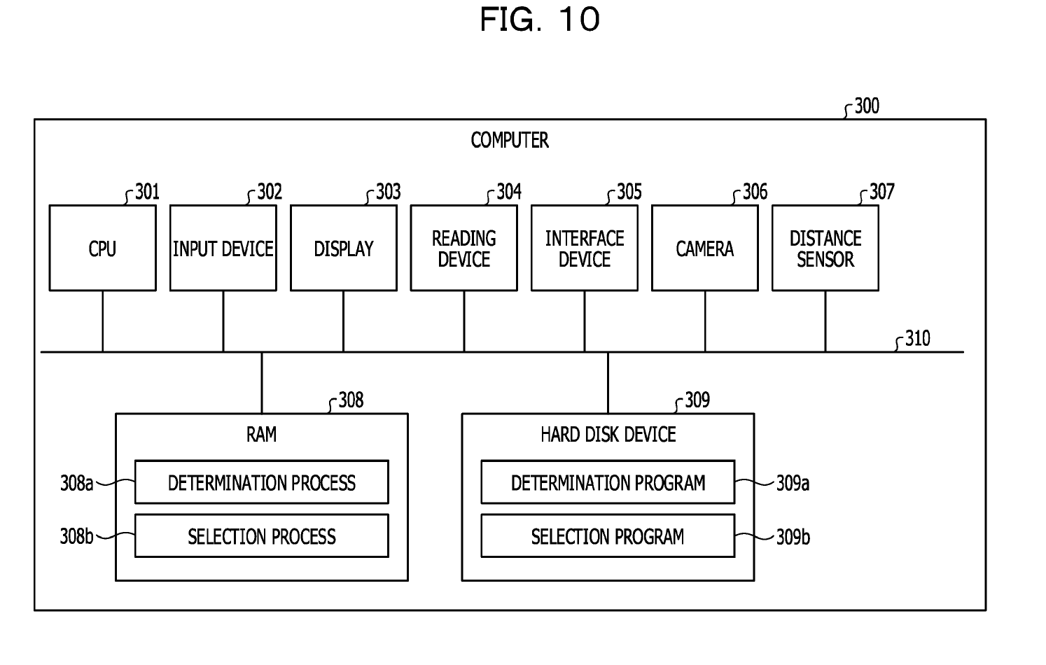

Next, description will be given of an example of a computer which executes a positional alignment program which realizes a similar function to the image processing device 100 illustrated in the embodiment described above. FIG. 10 is a diagram which illustrates an example of a computer which executes a positional alignment program.

As illustrated in FIG. 10, a computer 300 has a CPU 301 which executes various calculation processes, an input device 302 which receives the input of data from the user, and a display 303. In addition, the computer 300 has a reading device 304 which reads a program or the like from the storage medium, an interface device 305 which exchanges data with other computers via a network, a camera 306, and a distance sensor 307. In addition, the computer 300 has a RAM 308 which temporarily stores various types of information, and a hard disk device 309. Then, each device 301 to 309 is connected with a bus 310.

The hard disk device 309 has a determination program 309a and a selection program 309b. The CPU 301 reads and runs the determination program 309a and the selection program 309b in the RAM 308.

The determination program 309a functions as a determination process 308a. The selection program 309b functions as a selection process 308b. The process of the determination process 308a corresponds to the processes of the first determination unit 172, the second determination unit 173, and the third determination unit 174. The process of the selection process 308b corresponds to the process of the selection unit 175.

Here, the determination program 309a and the selection program 309b do not have to be stored in the hard disk device 309 from the beginning. For example, various programs may be stored in a “portable physical medium” such as a flexible disk (FD), a CD-ROM, a DVD disk, a magneto-optical disc, or an IC card inserted into the computer 300. Then, the computer 300 may read and execute each of the programs 309a and 309b.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An image processing method executed by a computer, the image processing method comprising:
determining overlap between a three-dimensional model of a space in which objects are arranged and first three-dimensional information acquired from a distance sensor at a first time point, the distance sensor being along with a camera which captures an image of the space;
determining another overlap between the three-dimensional model, the first three-dimensional information, and second three-dimensional information acquired from the distance sensor at a second time point after the first time point;
selecting a subset from within the first three-dimensional information and the second three-dimensional information, based on determination results of the overlap and the another overlap, the subset being used for performing positional alignment with the three-dimensional model;
estimating a position and an orientation of the camera by the positional alignment using the subset; and
generating a display screen displaying an object on the image according to the position and orientation.

2. The image processing method according to claim 1, wherein
the space is a work space, and
the computer is operated by a worker.

3. The image processing method according to claim 2, further comprising:
transmitting the display screen to another computer of an assistant supporting work of the worker.

4. The image processing method according to claim 1, further comprising:
determining a movement amount of the camera moved between the first time point up to the second time point.

5. The image processing method according to claim 4, wherein specific three-dimensional information included in common in the three-dimensional model, the first three-dimensional information, and the second three-dimensional information is selected as the subset when the overlap is a first threshold value or more, when the movement amount of the camera is less than a predetermined movement amount, and when the another overlap is a second threshold value or more.

6. The image processing method according to claim 4, wherein specific three-dimensional information included in common in the three-dimensional model, the first three-dimensional information, and the second three-dimensional information, and another specific three-dimensional information included in common in the three-dimensional model and the second three-dimensional information are selected as the subset when the movement amount of the camera is a predetermined movement amount or more, or when the another overlap is less than a second threshold value.

7. An image processing device comprising:
a memory; and
a processor coupled to the memory and configured to:
determine overlap between a three-dimensional model of a space in which objects are arranged and first three-dimensional information acquired from a distance sensor at a first time point, the distance sensor being along with a camera which captures an image of the space,
determine another overlap between the three-dimensional model, the first three-dimensional information, and second three-dimensional information acquired from the distance sensor at a second time point after the first time point,
select a subset from within the first three-dimensional information and the second three-dimensional information, based on determination results of the overlap and the another overlap, the subset being used for performing positional alignment with the three-dimensional model,
estimate a position and an orientation of the camera by the positional alignment using the subset, and
generate a display screen displaying an object on the image according to the position and orientation.

8. The image processing device according to claim 7, wherein
the space is a work space, and
the computer is operated by a worker.

9. The image processing device according to claim 8, wherein the processor is configured to:
transmit the display screen to another computer of an assistant supporting work of the worker.

10. The image processing device according to claim 7, wherein the processor is configured to:
determine a movement amount of the camera moved between the first time point up to the second time point.

11. The image processing device according to claim 10, wherein specific three-dimensional information included in common in the three-dimensional model, the first three-dimensional information, and the second three-dimensional information is selected as the subset when the overlap is a first threshold value or more, when the movement amount of the camera is less than a predetermined movement amount, and when the another overlap is a second threshold value or more.

12. The image processing device according to claim 10, wherein specific three-dimensional information included in common in the three-dimensional model, the first three-dimensional information, and the second three-dimensional information, and another specific three-dimensional information included in common in the three-dimensional model and the second three-dimensional information are selected as the subset when the movement amount of the camera is a predetermined movement amount or more, or when the another overlap is less than a second threshold value.

13. A non-transitory computer-readable medium storing an image processing program which, when executed, causes a computer to execute a process, the process comprising:
determining overlap between a three-dimensional model of a space in which objects are arranged and first three-dimensional information acquired from a distance sensor at a first time point, the distance sensor being along with a camera which captures an image of the space;
determining another overlap between the three-dimensional model, the first three-dimensional information, and second three-dimensional information acquired from the distance sensor at a second time point after the first time point;
selecting a subset from within the first three-dimensional information and the second three-dimensional information, based on determination results of the overlap and the another overlap, the subset being used for performing positional alignment with the three-dimensional model;
estimating a position and an orientation of the camera by the positional alignment using the subset; and
generating a display screen displaying an object on the image according to the position and orientation.

14. The non-transitory computer-readable medium according to claim 13, wherein
the space is a work space, and
the computer is operated by a worker.

15. The non-transitory computer-readable medium according to claim 14, further comprising:
transmitting the display screen to another computer of an assistant supporting work of the worker.

16. The non-transitory computer-readable medium according to claim 13, further comprising:
determining a movement amount of the camera moved between the first time point up to the second time point.

17. The non-transitory computer-readable medium according to claim 16, wherein specific three-dimensional information included in common in the three-dimensional model, the first three-dimensional information, and the second three-dimensional information is selected as the subset when the overlap is a first threshold value or more, when the movement amount of the camera is less than a predetermined movement amount, and when the another overlap is a second threshold value or more.

18. The non-transitory computer-readable medium according to claim 16, wherein specific three-dimensional information included in common in the three-dimensional model, the first three-dimensional information, and the second three-dimensional information, and another specific three-dimensional information included in common in the three-dimensional model and the second three-dimensional information are selected as the subset when the movement amount of the camera is a predetermined movement amount or more, or when the another overlap is less than a second threshold value.
